(19) United States
(12) Patent Application Publication
(10) Pub. No.: US 2024/0352553 A1
(43) Pub. Date: Oct. 24, 2024

(54) METHOD OF LEACHING METAL-CONTAINING MATERIALS

(71) Applicant: ARIZONA BOARD OF REGENTS ON BEHALF OF THE UNIVERSITY OF ARIZONA, Tucson, AZ (US)

(72) Inventors: Jaeheon Lee, Tucson, AZ (US); Jiajia Wu, Tucson, AZ (US)

(21) Appl. No.: 18/569,142

(22) PCT Filed: Jun. 9, 2022
(86) PCT No.: PCT/US2022/032909

§ 371 Date: Dec. 11, 2023

Related U.S. Application Data
(60) Provisional application No. 63/209,807, filed on Jun. 11, 2021.

(51) Int. Cl. C22B 7/00; C22B 3/00; C22B 3/04; C22B 3/44; C22B 26/12; C22B 47/00; H01M 10/54

(52) U.S. Cl. CPC C22B 7/006; C22B 3/04; C22B 3/44; C22B 23/0407; C22B 23/0461; C22B 26/12; C22B 47/00; H01M 10/54

(57) ABSTRACT

Methods are disclosed for leaching metal-containing materials, such as those contained in the cathode of spent lithium-ion batteries, using a leach solution of an amino acid and a reducing agent. The metal-containing material is treated with the leach solution to recover at least one metal. For example, when the metal-containing material is lithium cobalt (III) oxide (LiCoO₂), leaching with the leach solution of the present invention enables the recovery of the lithium and/or cobalt metal.

### CROSS-REFERENCE TO RELATED APPLICATIONS

This application claims the benefit of Provisional Appl. No. 63/209,807, filed Jun. 11, 2021. The content of the aforesaid application is relied upon and is incorporated by reference herein in its entirety.

### FIELD OF THE INVENTION

The field of the invention relates generally to extraction of metal from metal-containing materials. More particularly, the invention relates to extraction of metal from spent lithium-ion batteries.

### BACKGROUND

The demand for lithium-ion batteries (LIBs) for consumer electronics and automotive applications is expected to increase during the next 15-20 years (Steward et al., 2019).

Despite the development of high-performance electrode materials to meet the increasing demand for energy storage, lithium cobalt (III) oxide (LiCoO₂) remains the most common cathode material in LIBs for high specific energy, low rate of self-discharge, and simple manufacturing (Deng, 2015; Golmohammadzadeh et al., 2018). After a short life span of 3-8 years, the disposal of end-of-life LIBs should be carefully managed, to avoid contamination of soil, air, and groundwater (Liu et al., 2017). In addition, spent LIBs contain metals such as cobalt and lithium, and it is desirable to recover these metals. Thus, the recycling of spent LIBs is urgent in terms of environmental restriction, resource utilization and economic benefits.

Compared with the pyrometallurgy, a hydrometallurgical process is reported to provide an environmentally friendly and efficient method to recover valuable metals from the cathode of spent LIBs (Li et al., 2016). Inorganic acid, especially sulfuric acid, is widely used in the recycling process, but the high acid concentration needed can require expensive downstream processing. Environmentally benign and biodegradable chemicals, including organic acids such as citric acid, tartaric acid, malic acid, succinic acid, ascorbic acid have been explored as lixiviants in the treatment of spent LIBs (Dos Santos et al., 2019; Li et al., 2015; Musariri et al., 2019; Nayaka et al., 2016b). The leaching kinetics of organic acids are usually slower than those of inorganic acids due to higher pKa values. However, a potential advantage of using organic acids is their selectivity. According to Gao et al., cobalt and lithium can be selectively leached using organic acid, for separating valuable metals and Al foil (Gao et al., 2018).

Recently, glycine has been reported as a lixiviant in copper and gold leaching, with the assistance of hydrogen peroxide in an alkaline environment (Eksteen et al., 2017; Perea and Restrepo, 2018; Shin et al., 2019).

This background information is provided for the purpose of making information believed by the applicant to be of possible relevance to the present invention. No admission is necessarily intended, nor should it be construed, that any of the preceding information constitutes prior art against the present invention.

### SUMMARY

There is an urgent and increasing need for methods of recovering metals from lithium-ion batteries. The proliferation of consumer electronic devices and electronic vehicle lithium-ion batteries (LIBs) can be expected to accelerate rapidly. Improved and cost-effective methods are necessary for enabling the recycling of spent LIBs and reducing the environmental and economic impact of these materials critical to LIB chemistry.

In some embodiments, the invention provides method of leaching a metal-containing material (e.g., ore, concentrate, etc.), the method comprising:
a) forming a leach solution by dissolving at least one amino acid (e.g., glycine, histidine and/or lysine) and a reducing agent (e.g. sodium metabisulfite (SMB)) in water;
b) forming a mixture of the leach solution of step (a) and a metal-containing material;
c) leaching at least one metal from the metal-containing material by heating the mixture of step (b) in a temperature range from about 20° C. to about 100° C.

In some embodiments, the invention provides a method of recovering metal from a spent lithium-ion battery cathode, the method comprising:
a) separating the cathode components by one or more steps of removing adhesive used to adhere LiCoO₂ to an aluminum foil in the cathode (or in other words step (a) comprises separating the aluminum foil from LiCoO₂ to recover said LiCoO₂);
b) forming a leach solution by dissolving glycine and sodium metabisulfite in water;
c) forming a mixture of the leach solution of step (b) and LiCoO₂ from step (a);
d) leaching at least one metal from the metal-containing material by heating the mixture of step (c) in a temperature range from about 20° C. to about 100° C.

### BRIEF DESCRIPTION OF THE DRAWINGS

FIG. 1 is a graph showing speciation of glycine in water at various pH values.

FIG. 2 is a chart showing and XRD pattern of LiCoO₂ powder.

FIGS. 3A and 3B are graphs showing an effect of Na₂S₂O₅ on LiCoO₂ dissolution using 0.5 M glycine at 80° C.; FIG. 3A shows the percentage (%) of Co recovery, and FIG. 3B shows Li recovery (%).

FIGS. 4A and 4B are graphs showing an effect of glycine concentration on LiCoO₂ dissolution using 0.5 M Na₂S₂O₅ at 80° C.; FIG. 4A shows Co recovery (%); FIG. 4B shows Li recovery (%).

FIGS. 5A and 5B are graphs showing an effect of solid/liquid ratio on LiCoO₂ dissolution using 0.5 M glycine and 0.5 M Na₂S₂O₅ at 80° C.; FIG. 5A shows metal recovery (%), and FIG. 5B shows metal concentration as molarity (M).

FIGS. 6A and 6B are graphs showing an effect of temperature on LiCoO₂ dissolution using 0.5 M glycine and 0.5 M Na₂S₂O₅; FIG. 6A shows Co recovery (%), and FIG. 6B shows Li recovery (%).

FIG. 7 is a graph showing an Arrhenius plot of Co and Li.

FIGS. 8A and 8B are graphs of XPS spectra; FIG. 8A shows Co 2p core peaks for three samples (S1, S2, S3); FIG. 8B shows O 1s core peaks for the three samples (S1, S2, S3).

FIGS. 9A and 9B are SEM (scanning electron microscopy) images of original LiCoO₂ powder (FIG. 9A) and leaching residue (FIG. 9B), respectively.

FIG. 10 is an SEM image of a leaching residue from after leaching LiCoO₂ powder with 0.5 M glycine and 1.0 M Na₂S₂O₅.

FIGS. 11A to 11F are SEM and EDS (electron dispersive X-ray microanalysis) images of a leaching residue from after leaching LiCoO₂ powder with 0.5 M glycine and 1.0 M Na₂S₂O₅. FIG. 11A is an SEM image of the residue. The images in FIGS. 11B to 11F show EDS analyses of the residue for the elements Co, O, S, Na and C, respectively.

FIGS. 12A and 12B show an SEM image (FIG. 12A) of a cubic particle of residue from after leaching LiCoO₂ powder with 0.5 M glycine and 1.0 M Na₂S₂O₅, and EDS analysis results (FIG. 12B) of the inset region in FIG. 12A.

FIG. 13 is a graph showing solution pH and potential during a leaching using optimized concentrations of glycine and Na₂S₂O₅, at 80° C.

FIGS. 14A and 14B are graphs showing Eh-pH diagrams for Co (FIG. 14A) and Li (FIG. 14B) in glycine-sodium metabisulfite leaching system at 25° C. (solid line) and 80° C. (dashed line), [Co]═[Li]=0.2 M, [glycine]=[Na₂S₂O₅]=0.5 M.

### DETAILED DESCRIPTION

### Definitions

For the purposes of promoting an understanding of the principles of the invention, reference will now be made to certain embodiments and specific language will be used to describe the same. It will nevertheless be understood that no limitation of the scope of the invention is thereby intended, and alterations and modifications in the illustrated invention, and further applications of the principles of the invention as illustrated therein are herein contemplated as would normally occur to one skilled in the art to which the invention relates.

Unless defined otherwise, all technical and scientific terms used herein have the same meaning as commonly understood by one of ordinary skill in the art to which this invention pertains.

For the purpose of interpreting this specification, the following definitions will apply and whenever appropriate, terms used in the singular will also include the plural and vice versa. In the event that any definition set forth below conflicts with the usage of that word in any other document, including any document incorporated herein by reference, the definition set forth below shall always control for purposes of interpreting this specification and its associated claims unless a contrary meaning is clearly intended (for example in the document where the term is originally used).

The use of “or” means “and/or” unless stated otherwise.

The use of “a” or “an” herein means “one or more” unless stated otherwise or where the use of “one or more” is clearly inappropriate.

The use of “comprise,” “comprises,” “comprising,” “include,” “includes,” and “including” are interchangeable and not intended to be limiting. Furthermore, where the description of one or more embodiments uses the term “comprising,” those skilled in the art would understand that, in some specific instances, the embodiment or embodiments can be alternatively described using the language “consisting essentially of” and/or “consisting of.”

As used herein, the term “about” refers to a ±10% variation from the nominal value. It is to be understood that such a variation is always included in any given value provided herein, whether or not specifically referred to.

As used herein, the term “Eh” refers to a measure of the redox (oxidation-reduction) state of a solution or, more exactly, its solutes.

One aspect of the invention pertains to a solution for leaching a metal-containing material. In some embodiments, the leach solution comprises glycine and a reducing agent.

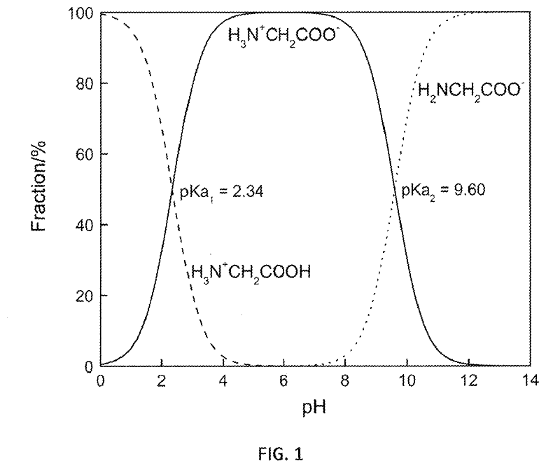

Glycine (NH₂CH₂COOH) has two pKa values, 2.34 and 9.60, because of the presence of an amino group and a carboxyl group (Smith and Martell, 1989). Protonation of the amino group in glycine happens under acidic conditions, forming a cationic species (⁺NH₃CH₂COOH). A zwitterionic species (⁺NH₃CH₂COO—) dominates in the pH region from 4 to 8 with the deprotonation in the carboxyl group. At alkaline pH, deprotonation of glycine forms an anionic species (NH₂CH₂COO—). Speciation of glycine in an aqueous solution as a function of pH is shown in FIG. 1.

Glycine can form coordination compounds with some metal ions over a pH range of 2-11. The speciation of metal-glycinate is dependent on solution pH, oxidation status of metal ion, and metal ion concentration (Borsook and Thimann, 1932; Keefer, 1948; Prasad and Prasad, 2009).

Stability constants of some metal-glycinate complexes are listed in Table 1 (Angkawijaya et al., 2012; Azadi et al., 2019; Lotfi et al., 2009). Stability constant can be calculated by thermodynamic data indicating potentials of metal dissolution. These metals listed here can be complexed with glycine in the solution so it can be used to metal extraction/recovery process.

TABLE 1
Equilibrium stability constants of metal
ions with glycine at standard state.

| Metal | logβ₁ | logβ₂ | logβ₃ |
|---|---|---|---|
| Cu²⁺ | 8.26 | 15.15 | 17.24 |
| Cu⁺ | 6.75 | 10.00 | — |
| Ni²⁺ | 5.83 | 10.70 | 13.92 |
| Co²⁺ | 4.82 | 8.74 | 11.63 |
| Mn²⁺ | 3.01 | 5.00 | 5.70 |
| Zn²⁺ | 5.10 | 9.40 | 11.59 |
| Cd²⁺ | 4.40 | 7.84 | 10.31 |
| Pb²⁺ | 5.18 | 8.44 | — |
| Pd²⁺ | 9.12 | 17.55 | — |
| Fe²⁺ | 4.02 | 6.65 | — |
| Ag⁺ | 3.43 | 6.71 | — |
| Au³⁺ | 7.05 | 10.57 | — |
| Au⁺ | — | 16.70 | — |

In some embodiments of the present invention, the leach solution includes a reducing agent. Inclusion of a reducing agent can enhance the ability to leach metal(s) from a metal-containing material. A variety of reducing agents have been investigated, paired with different acids to leach cathode materials of LIBs. For example, the utilization of H₂O₂ can improve leaching efficiency without introducing extra ions into leaching systems. However, at elevated temperatures the decomposition of H₂O₂ increases, leading to higher reagent consumption. Moreover, the oxidative degradation of some organic acids (e.g., ascorbic acid) by H₂O₂ was reportedly detrimental for metal extraction (Deutsch, 1998).

In some embodiments of the present invention, the reducing agent is included to enhance the leaching of metal-containing materials, including the LiCoO₂ commonly used in cathodes of LIBs. Cobalt exists as Co(III) in the LiCoO₂ crystal structure, which has been difficult to leach. In a leaching process without a reducing agent, CO₃O₄ may be formed as an intermediate oxide, which is not readily soluble (Musariri et al., 2019). The chemical bonds in the LiCoO₂ crystal become weaker after Co (III) is reduced, and Co (II) can then be dissolved in an aqueous solution more readily.

Sodium metabisulfite (SMB, Na₂S₂O₅) exhibits a reducing ability, and it is commonly used as a preservative in food and pharmaceutical industries (Ahmadi et al., 2018). In gold leaching, it is also used as an inhibitor for thiosulfate oxidation to minimize reagent loss (Fleming et al., 2000). SMB is also available commercially in industrial scale. The present disclosure describes a valuable metal extraction from LiCoO₂ powder in a leaching system of glycine and sodium metabisulfite (glycine-SMB), where glycine serves as a lixiviant and SMB is a reducing agent. Preferred conditions were studied, and a leaching mechanism was also proposed.

One aspect of the invention pertains to a method of leaching a metal-containing material (e.g., ore, concentrate, etc.), the method comprising:
a) forming a leach solution by dissolving at least one amino acid (e.g., glycine, histidine and/or lysine and a reducing agent (e.g. sodium metabisulfite (SMB)) in water;
b) forming a mixture of the leach solution of step (a) and a metal-containing material;
c) leaching at least one metal from the metal-containing material by heating the mixture of step (b) in a temperature range from about 20° C. to about 100° C. or about 10° C. to about 95° C.

In some embodiments, the metal-containing material comprises LiCoO₂.

In some embodiments, the metal-containing material comprises one or more lithium compounds.

In some embodiments, the at least one metal leached from the metal-containing material comprises lithium, cobalt, manganese or nickel (e.g., for battery recycling, using the present invention the metals leached may be manganese and/or nickel).

In some embodiments, wherein the at least one amino acid is chosen from glycine, histidine and lysine.

In some embodiments, the concentration of the glycine in the leach solution is in a range from about 0.01M to about 2.0M, or from about 0.3 M to about 1.5 M, or even about 0.5 M.

In some embodiments, the reducing agent is sodium metabisulfite.

In some embodiments, the concentration of the sodium metabisulfite in the leach solution is in a range from about 0.1M to about 2.0 M, or from about 0.1 M to about 1.0 M, or even about 0.5 M.

In some embodiments, said method further comprises adjusting the pH of the leach solution to a pH from about 1 to about 14, or from about 3 to about 7, or even from about 4.5 to 5.5.

In some embodiments, the metal-containing material is leached for a duration of about 10 minutes to about 180 minutes, or about 1 hour to about 96 hours.

In some embodiments, the said metal-containing material is an ore or concentrate.

Another aspect of the invention is a method of recovering metal from a spent lithium-ion battery cathode, the method comprising:
a) separating the cathode components comprising separating an aluminum foil in the cathode from a lithium containing material (e.g. material containing LiCoO₂) to recover said one or more lithium containing material (such as a material comprising LiCoO₂);
b) forming a leach solution by dissolving an amino acid (e.g. glycine) and a reducing agent (e.g. sodium metabisulfite) in water;
c) forming a mixture of the leach solution of step (b) and lithium containing material (such as LiCoO₂) from step (a);
d) leaching lithium and/or cobalt from the lithium containing material by heating the mixture of step (c) in a temperature range from about 20° C. to about 100° C.

In some embodiments, the separating in step (a) comprises physical separating using a method comprising crushing, milling, and/or air/gravity separation and collecting the resulting or separated lithium containing material (e.g. LiCoO₂).

In some embodiments, said temperature range is from about 10° C. to about 95° C.

A further aspect the invention, a method for leaching nickel and/or manganese from used batteries, the method comprising:
a) separating a nickel and/or manganese containing material from one or more used batteries;
b) forming a leach solution by dissolving at least one amino acid and a reducing agent in water;
c) forming a mixture of the leach solution of step (b) and a metal-containing material;
d) leaching at least nickel and/or manganese from the metal-containing material by heating the mixture of step (c) in a temperature range from about 20° C. to about 100° C. or about 10° C. to about 95° C.
wherein said at least one amino acid is chosen from glycine, histidine and lysine.

In some embodiments, said a reducing agent is sodium metabisulfite (SMB).

In some embodiments, said temperature range is from about 10° C. to about 95° C.

In some embodiments, the metal-containing material comprises one or more nickel compounds and/or one or more manganese compounds.

### LIST OF EMBODIMENTS

The following is a non-limiting list of embodiments of the present invention:

Embodiment 1. A method of leaching a metal-containing material (e.g., ore, concentrate, etc.), the method comprising:
(a) forming a leach solution by dissolving at least one amino acid (e.g., glycine, histidine and/or lysine) and a reducing agent (e.g., sodium metabisulfite (SMB)) in water;
(b) forming a mixture of the leach solution of step (a) and a metal-containing material;
(c) leaching at least one metal from the metal-containing material by heating the mixture of step (b) in a temperature range from about 20° C. to about 100° C. or about 10° C. to about 95° C.

Embodiment 2. The method of embodiment 1, wherein the metal-containing material comprises LiCoO₂.

Embodiment 3. The method of embodiment 1, wherein the at least one metal leached from the metal-containing material comprises lithium, cobalt, manganese or nickel (e.g, for battery recycling, using the present invention the metals leached may be manganese and/or nickel).

Embodiment 4. The method of embodiment 1, wherein a concentration of the glycine in the leach solution is in a range from about 0.01M to about 2.0M or from about 0.3 M to about 1.5 M.

Embodiment 5. The method of embodiment 1, wherein a concentration of the sodium metabisulfite in the leach solution is in a range from about 0.1M to about 2.0M or from about 0.1 M to about 1.0 M.

Embodiment 6. The method of embodiment 1, further comprising adjusting the pH of the leach solution to a pH from about 1 to about 14 (e.g., a pH of about 5).

Embodiment 7. The method of embodiment 1, wherein the metal-containing material is leached for a duration of about 10 minutes to about 180 minutes, or about 1 hour to about 96 hours.

Embodiment 8. A method of recovering metal from a spent lithium-ion battery cathode, the method comprising:
(a) separating the cathode components by one or more steps of removing adhesive used to adhere LiCoO₂ to an aluminum foil in the cathode (or in other words step (a) comprises separating the aluminum foil from LiCoO₂ to recover said LiCoO₂);
(b) forming a leach solution by dissolving glycine and sodium metabisulfite in water;
(c) forming a mixture of the leach solution of step (b) and LiCoO₂ from step (a);
(d) leaching at least one metal from the metal-containing material by heating the mixture of step (c) in a temperature range from about 20° C. to about 100° C.

Embodiment 9. The method of embodiment 8, wherein the separating in step (a) comprises physical separating using a method comprising crushing, milling, and/or air/gravity separation and collecting resulting or separated LiCoO₂.

In some embodiments of the present disclosure, the temperature of the leaching is in a range of from about 20° C. to about 100° C., or from about 10° C. to about 95° C., or even about 80° C.

In some embodiments of the present disclosure, the pH of the leaching solution is at least about 2, at least about 3, at least about 4, at least, about 5, at least about 6, and even at least about 7. In some embodiments, the pH of the leaching solution is in a range of from about 3 to about 7, from about 4 to about 6, and even from about 4.5 to about 5.5. In some embodiments, the pH of the leaching solution is about 5.

In some embodiments of the present disclosure, the concentration of glycine is in a range from about 0.01M to about 2.0M.

In some embodiments of the present disclosure, the concentration of reducing agent is from about 0.1M to about 2.0M.

In some embodiments of the present disclosure, the duration of leching the metal-containing material is in a range from about 1 hour to 96 hours.

It is to be understood that both the foregoing general description of the invention and the following detailed description are exemplary, and thus do not restrict the scope of the invention.

### EXAMPLES

### Materials

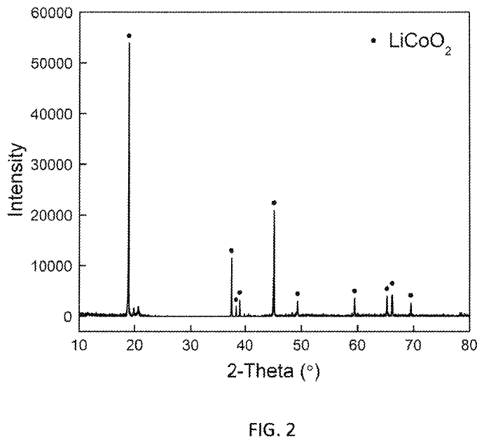

The reagent grade lithium cobalt(III) oxide powder (LiCoO₂, 97% purity, Alfa Aesar, USA) was used as a raw material for the study. The composition was analyzed by X-ray powder diffraction (XRD), and the result can be seen in FIG. 2. The XRD pattern was in good agreement with the JCPDS card (No. 01-075-0532) of LiCoO₂.

Leaching experiments were conducted in a beaker with a watch glass cover to prevent the evaporative loss of solution. First, the leaching solution was made by adding specific amounts of chemical reagents to deionized water, and heating to 80° C. using a hot plate. When the temperature reached a set point, 2.0 g LiCoO₂ powder sample was added into the solution, along with additional deionized water to bring the solution volume to 100 mL. During the test, 5 mL kinetic samples at 45, 90, and 180 minutes were taken using a syringe filter with 0.45 micrometer pore size. Meanwhile, pH and oxidation-reduction potential (ORP) value were recorded. The kinetic samples were assayed by Atomic Absorption Spectrophotometer (AAS, PinAAcle 500, Perkin-Elmer, USA) for cobalt and lithium concentrations. After leaching tests, residues were filtered, washed three times using deionized water, and dried at the ambient atmosphere for further analysis. Co and Li recoveries were calculated using Equation (1):

$$R = \frac{c \cdot V}{m \cdot w} \times 100 \% \qquad ( 1 )$$

where R is the recovery of Co or Li (%); c is the concentration of metal ions in solution (g/L); V is the volume of leaching solution (L); m is the weight of LiCoO₂ used in the test (g); w is Co or Li content in LiCoO₂ powder. The cumulative recovery was calculated at leaching times of 90 minutes and 180 minutes.

### Material Characterization

LiCoO₂ powders were characterized before and after leaching in the glycine-SMB system, using X-ray photoelectron spectroscopy (XPS) and scanning electron microscope (SEM) techniques. XPS measurements were carried out with a Kratos Axis 165 Ultra spectrometer using a focused monochromatized Al Kα radiation (1486.6 eV). All spectra were calibrated using the C 1s peak at 284.8 eV. Core peaks were analyzed using a nonlinear Shirley-type background. The high-resolution XPS spectra were analyzed using a peak-fit program with Gaussian-Lorentzian sum function. The morphology analysis was conducted by SEM with energy dispersive X-ray microanalysis (SEM-EDS, Hitachi S-4800).

### Leaching Study

### Effect of Reductant Concentration

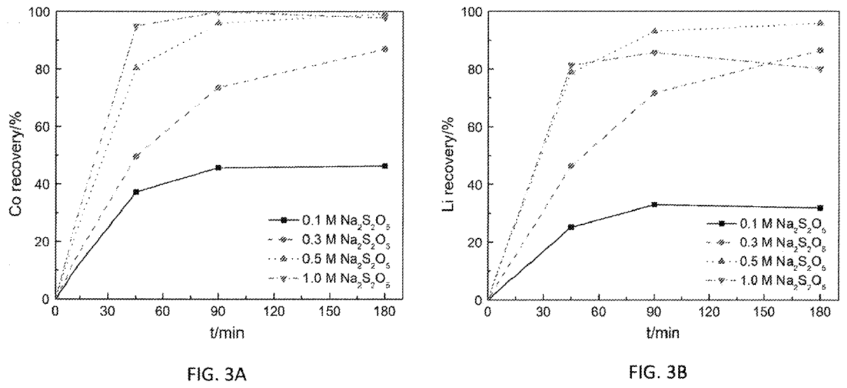

The effect of Na₂S₂O₅ concentration was studied at a glycine concentration of 0.5 M. The results Co and Li recovery are shown in FIGS. 3A and 3B, respectively.

Co and Li recovery were strongly affected by the concentration of Na₂S₂O₅ at 80° C.

When Na₂S₂O₅ concentration increased from 0.1 M to 0.5 M, Co extraction increased from 46.3% to 99.2% and Li recovery grew from 29.0% to 95.7% after 180 min. However, a further increase of Na₂S₂O₅ concentration to 1.0 M did not improve the LiCoO₂ dissolution. Although faster kinetics were observed, Co extraction decreased by 1.6% from 90 min to 180 min. Similarly, an apparent drop of Li concentration in leachate was also observed from 90 min to 180 min. After the leaching test, a brown precipitate was found, which was analyzed and discussed in the following sections. From this study, a preferred Na₂S₂O₅ concentration was found to be 0.5 M.

Li recovery and leaching kinetics were lower than those of Co with 0.1 M Na₂S₂O₅, but improvement was observed with higher Na₂S₂O₅ concentration. For example, when using 0.5 M Na₂S₂O₅, similar leaching kinetics of Co and Li were obtained. The results were consistent with needing the reduction of Co (III) and release of Co from LiCoO₂ crystal structure in order to obtain Li dissolution, while Li did not need to be reduced. The slow leaching kinetics of Li in organic acid leaching systems can also be found in published literature, implying that the leaching of Li may be affected by solution chemistry (Fu et al., 2019; Li et al., 2015; Nayaka et al., 2016a).

### Effect of Glycine Concentration

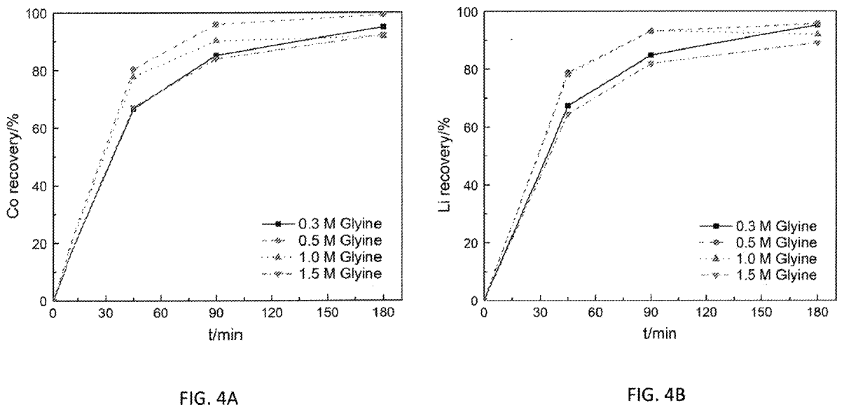

FIGS. 4A and 4B illustrate the leaching behavior of LiCoO₂ using 0.5 M Na₂S₂O₅ with various glycine concentrations, with FIG. 4A showing the results for Co and FIG. 4B showing the results for Li. Cobalt leaching kinetics and overall recovery improved when glycine concentration increased from 0.3 M to 0.5 M. Meanwhile, lithium leaching kinetics were faster with 0.5 M glycine, but the ultimate Li recoveries were about the same after 180 min, around 95%. Higher levels of glycine (e.g., 1.0 M and 1.5 M) resulted in decreased Co and Li leaching kinetics and the recovery to different extents. This is possibly due to high ionic strength of the leaching solution. In theory, higher ionic strengths resulted in not only lowering the ionic mobility and thus hindered mass transfer but also possibly the precipitation formation in the leaching solution (Bahga et al., 2010). On the other hand, higher glycine dosages than stoichiometric amount were observed to only contributed to a product with a higher glycine/metal ratio, rather than accelerating the leaching speed. A glycine concentration of 0.5 M was therefore selected for leaching studies.

### Effect of Solid/Liquid Ratio

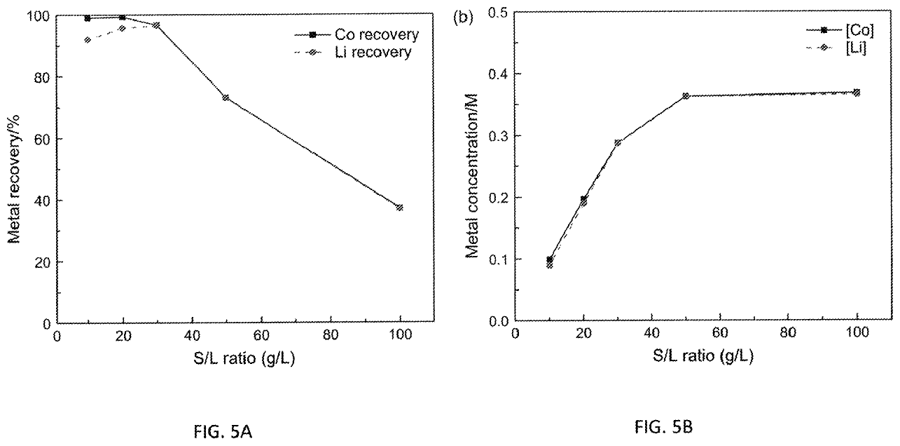

The effect of solid/liquid ratio was tested with the following conditions: 0.5 M glycine, 0.5 M Na₂S₂O₅, 180 min leaching time, and a temperature of 80° C. Co and Li leaching recovery and concentration in leachate with various S/L ratios were as shown in FIGS. 5A and 5B. At higher S/L ratios, there was a decrease in metal recovery. Co and Li leaching recoveries were above 95% when S/L ratio was less than 30 g/L. The highest Co and Li leaching recovery was observed with the S/L ratio of 20 g/L.

The molar (M) concentrations of Co and Li in leachate were almost equivalent under the same conditions, (i.e, 0.5M glycine and 0.5M SMB) indicating that they were dissolved from LiCoO₂ in the atomic ratio of about 1:1. The soluble Co and Li species increased with S/L ratio and reached a plateau of 0.36 M with an S/L ratio of 50 g/L. Under these conditions, the cobalt-glycinate complex was possibly Co₂(NH₂CH₂COO)₃ (Borsook and Thimann, 1932). Accordingly, the decrease of metal extraction at high S/L ratios was possibly due to a depleted level of leaching reagents.

### Effect of Temperature

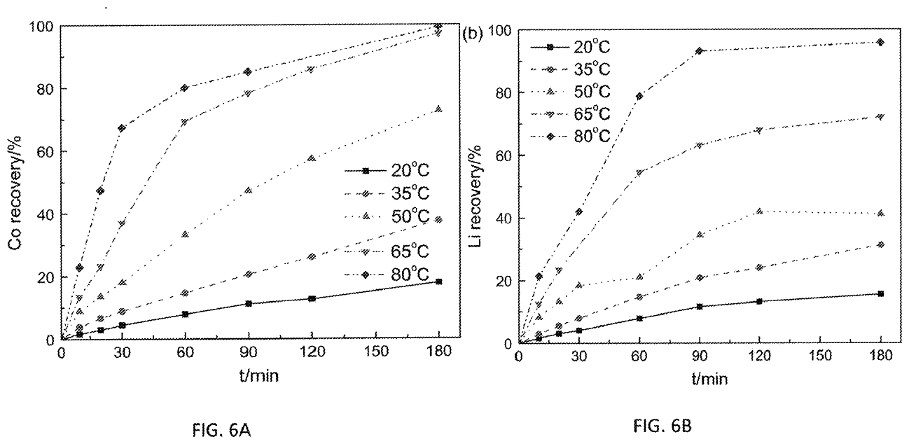

To gain further insights into the LiCoO₂ dissolution behavior at different temperatures in the glycine-SMB system, tests were conducted using 0.5 M glycine and 0.5 M Na₂S₂O₅ at temperatures in of range from 20° C. to 80° C. The resulting Co and Li leaching behavior at different temperatures is illustrated in FIGS. 6A and 6B.

As shown in FIGS. 6A and 6B, an increase in temperature accelerated LiCoO₂ dissolution in the glycine-SMB leaching system, which can be seen from the increased leaching kinetics and recovery for Co (FIG. 6A) and Li (FIG. 6B). At temperatures below 65° C., Co and Li recovery increased steadily with leaching time. Co and Li extraction still showed an upward trend after 180 min. It is believed that the dissolution of LiCoO₂ at low temperatures was a slow process (not ceased within 3 hours). The highest leaching kinetics and recovery were observed at 80° C.

### Leaching Kinetics

Making an assuming that LiCoO₂ powders are spherical particles and the unreacted core shrinks during leaching, a shrinking core model was applied to explain the leaching mechanism, as shown in Eqs. (2)-(4) (Levenspiel, 1999). Equation (2) represents a surface chemical reaction-controlled model, Eqs. (3) and (4) are expressions for product layer diffusion and boundary layer diffusion limited models, respectively.

$$1 - {( 1 - x )}^{\frac{1}{3}} = kt \qquad ( 2 )$$

$$1 - \frac{2}{3} x - {( 1 - x )}^{\frac{2}{3}} = kt \qquad ( 3 )$$

$$1 - {( 1 - x )}^{\frac{2}{3}} = kt \qquad ( 4 )$$

where: x is fraction reacted (metal recovery), k is rate constant (min⁻¹), t is leaching time (min). The leaching rate constants and the coefficients of determination from these three models for Co and Li leaching are shown in Tables 2 and 3, respectively.

TABLE 2
Fitting parameters of shrinking core model for Co leaching

| | Surface chemical reaction | | Diffusion through | | Diffusion through | |
|---|---|---|---|---|---|---|
| | control | | product layer | | boundary layer | |
| | 1-(1-x)^{1/3} = kt | | 1-2/3x-(1-x)^{2/3} = kt | | 1-(1-x)^{2/3} = kt | |
| T/° C. | k*10⁻³/(min⁻¹) | R² | k*10⁻³/(min⁻¹) | R² | k*10-3/(min⁻¹) | R² |
| 20 | 0.349 | 0.987 | 0.021 | 0.963 | 0.675 | 0.985 |
| 35 | 0.779 | 0.998 | 0.101 | 0.926 | 1.447 | 0.997 |
| 50 | 1.948 | 0.998 | 0.523 | 0.962 | 3.226 | 0.990 |
| 65 | 4.167 | 0.982 | 1.415 | 0.980 | 6.297 | 0.952 |
| 80 | 10.452 | 0.994 | 2.569 | 0.901 | 17.684 | 0.999 |

TABLE 3
Fitting parameters of shrinking core model for Li leaching

| | Surface chemical reaction | | Diffusion through | | Diffusion through | |
|---|---|---|---|---|---|---|
| | control | | product layer | | boundary layer | |
| | 1-(1-x)^{1/3} = kt | | 1-2/3x-(1-x)^{2/3} = kt | | 1-(1-x)^{2/3} = kt | |
| T/° C. | k*10⁻³/(min⁻¹) | R² | k*10⁻³/(min⁻¹) | R² | k*10⁻³/(min⁻¹) | R² |
| 20 | 0.317 | 0.950 | 0.017 | 0.983 | 0.616 | 0.947 |
| 35 | 0.658 | 0.981 | 0.072 | 0.982 | 1.239 | 0.976 |
| 50 | 1.274 | 0.968 | 0.198 | 0.938 | 2.327 | 0.964 |
| 65 | 3.204 | 0.980 | 0.775 | 0.986 | 5.457 | 0.970 |
| 80 | 5.379 | 0.978 | 0.835 | 0.988 | 9.816 | 0.970 |

By comparing these three models, the chemical reaction control model fitted the Co leaching results well, with high coefficients of determination, suggesting the surface chemical reaction of Co (III) reduction by Na₂S₂O₅ may govern the cobalt dissolution. For Li leaching, higher correlation coefficients were found in models of the surface chemical reaction control and the diffusion through the product layer. In the present study, there was no presence of impurities such as organic binders accumulating on the LiCoO₂ surface to limit diffusion, since high purity synthetic LiCoO₂ powder was used as raw material (Musariri et al., 2019). Also, Co-glycinate diffusion from particle surface to solution bulk was a rapid step. Therefore, a product layer was not likely to be formed, and the Li leaching was mainly limited by surface chemical reaction, consistent with a reductive dissolution of Co facilitating Li dissolution from LiCoO₂ crystal.

The relationship between reaction rate constant and temperature can be described by Arrhenius law, shown as Equation (5). Equation (6) is the logarithm form.

$$k = A {e}^{- {E}_{a} / RT} \qquad ( 5 )$$

$$1 nk = ln A - \frac{{E}_{a}}{R} \cdot \frac{1}{T} \qquad ( 6 )$$

where k is the reaction constant (h⁻¹), A is the frequency factor, Eₐ is the apparent activation energy (kJ/mol), R is the universal gas constant (8.314 J/K/mol), and T is the absolute temperature (K).

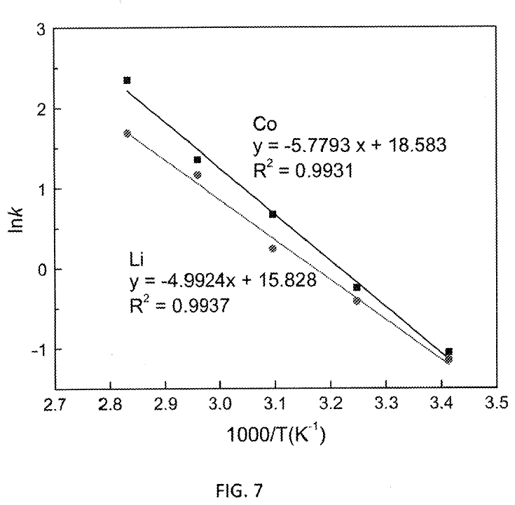

Using the rate constants calculated from the surface chemical reaction-controlled model listed in Tables 2 and 3, the Arrhenius plots of Co and Li were constructed, with results as shown in FIG. 7. A good linear relationship (i.e., a good linear relationship with R-square values of 0.9931 and 0.9937 for Co and Li, respectively) was found between lnk and 1/T. The apparent activation energies of Co and Li dissolution from LiCoO₂ were determined to be 48.05 kJ/mol and 41.51 kJ/mol, respectively. The high activation energy confirmed the metal ion extraction from LiCoO₂ using glycine and SMB was controlled by surface chemical reaction.

### Microanalytical Characterization

To confirm the leaching results and determine the composition of the precipitates formed during the leaching experiments, microanalysis using XPS and SEM were performed on the LiCoO₂ pristine sample and two selected experimental residues. The sample information is listed in Table 4. LiCoO₂ powder without any treatment is labeled as S1; residues of leaching tests using 0.5 M glycine and 0.3 and 1.0 M Na₂S₂O₅ were S2 and S3, respectively. It should be noted that there was no detectable leaching residue using 0.5 glycine and 0.5 M Na₂S₂O₅ since LiCoO₂ was fully dissolved into leaching solution.

Sample S2 is a black residue while sample S3 is a brownish powder; their compositions and morphologies were as determined here.

TABLE 4
Sample information for XPS analysis

| No. | Sample | Condition |
|---|---|---|
| S1 | LiCoO₂ powder | Without treatment |
| S2 | residue | 0.5M glycine and 0.3M Na₂S₂O₅ |
| S3 | residue | 0.5M glycine and 1.0M Na₂S₂O₅ |

### XPS Analysis

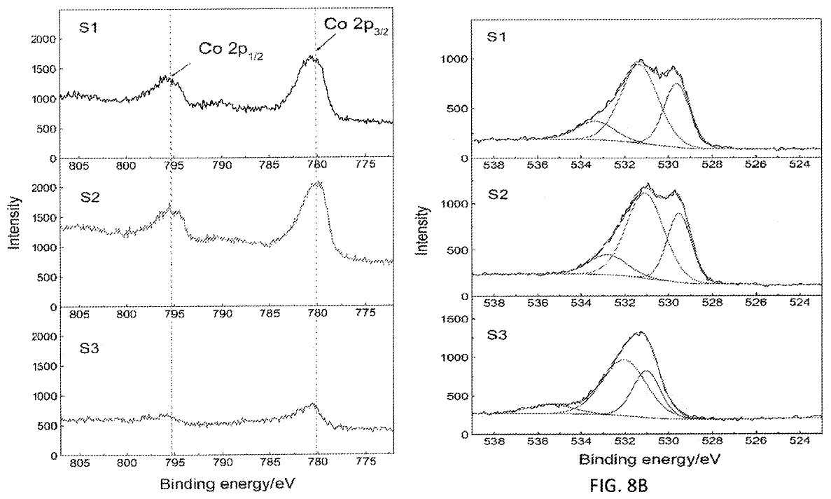

FIG. 8A display the Co 2p and O 1s core peaks of the three samples S1-S3. Due to the spin-orbit coupling, the Co 2p spectrum is split into two parts (2p_{3/2} and 2p_{1/2}) with an intensity ratio close to 2:1. Similar Co 2p spectra were observed in sample S1 and S2 with binding energies of Co 2p_{3/2} and 2p_{1/2} near 780 and 795 eV, respectively, indicating the existence of cobalt in the two samples was the same, from LiCoO₂ crystal structure (cf. Guan et al., 2016; van Elp et al., 1991). The chemical state of cobalt can be determined by satellite peak. The absence of satellite peak at 786 eV showed it is Co (III) in LiCoO₂ crystal. A significant decrease of Co 2p intensity was detected in sample S3, suggesting the cobalt content in the residue was lower than sample S1 and S2. On the other hand, the Co 2p_{3/2} peaked at around 781.5 eV, showing the valence of cobalt in the residue was +2 (Chen et al., 2016).

The O is spectra and peak fitting results of the three samples were as shown in FIG. 8B. The binding energy of O is at 529.5 eV in sample S1 and S2 is characteristic of the lattice oxygen from LiCoO₂, in good agreement with the literature (van Elp et al., 1991). Another peak at 531.2±0.1 eV can be attributed to carbonate and hydroxide species, indicating the surface contamination by water, CO₂, hydroxide species, or surface defects (Dahe\acute{ } ron et al., 2009; Han et al., 2015). Water molecule absorbed on LiCoO₂ surface was also found due to the peaks at ˜533 eV (Weidler et al., 2016). In sample S3, O 1s peak at 529.5 eV was disappeared, indicating the metal oxide structure of LiCoO₂ was destructed. The three peaks detected were at higher binding energies of 531.0 eV, 532.0 eV, and 535.4 eV. The first two peaks can be assigned as carbonate or hydroxide and organic C═O bond, respectively (Zhang et al., 2014). The peak at 535.4 eV is caused by the sodium Auger peak considering the high sodium concentration in leaching solution may evolved in the precipitation process. Therefore, it was deduced that sample S2 was mainly undissolved LiCoO₂ powder while sample S3 was a precipitate with a complex composition.

### SEM Characterization

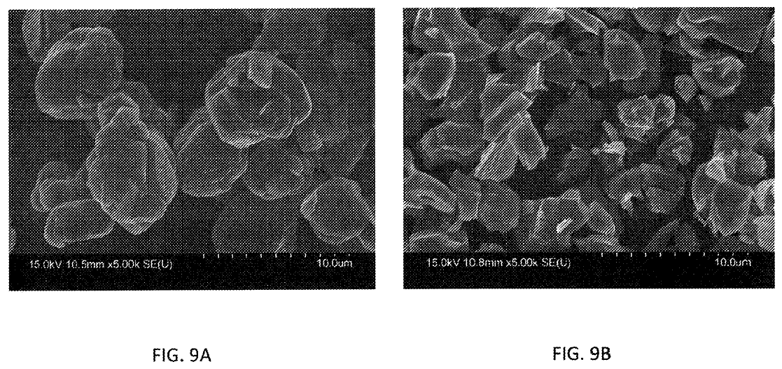

SEM images of the original LiCoO₂ powder (sample S1) and leaching residue of 0.5 M glycine and 0.3 M Na₂S₂O₅ (sample S2) are shown in FIGS. 9A and 9B, respectively. In FIG. 9A, the raw material of LiCoO₂ powder showed a larger particle size of 4-6 micrometers with a smooth surface. The LiCoO₂ crystal structure was damaged by glycine and Na₂S₂O₅ during leaching, and a significant reduction of size was found in sample S2, as shown in FIG. 9B. Moreover, the smooth semi-spherical surface was reduced, and sharp edges were also observed from the particles. From XPS analysis results, it is undissolved LiCoO₂ particles.

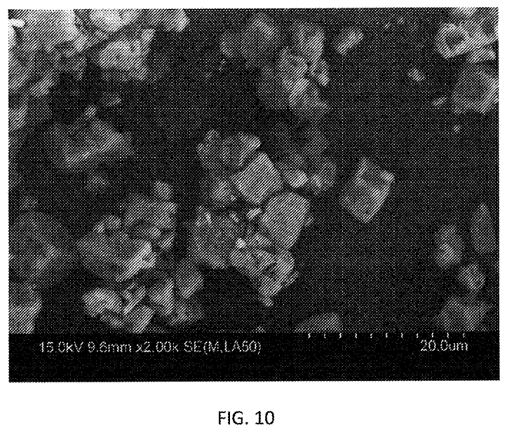

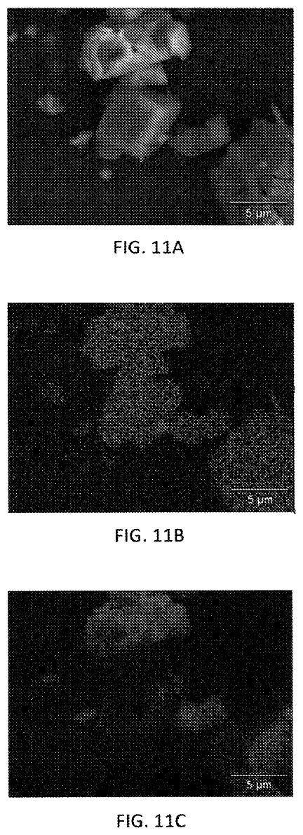

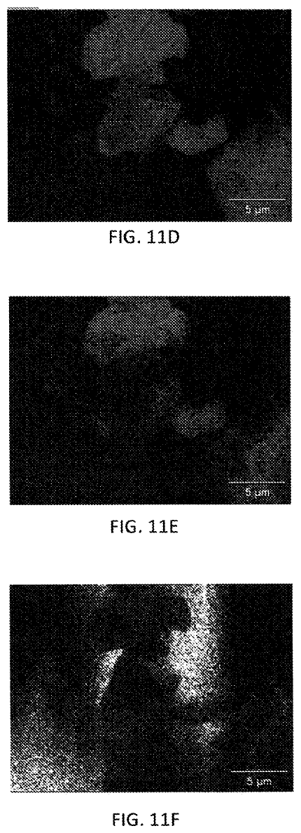

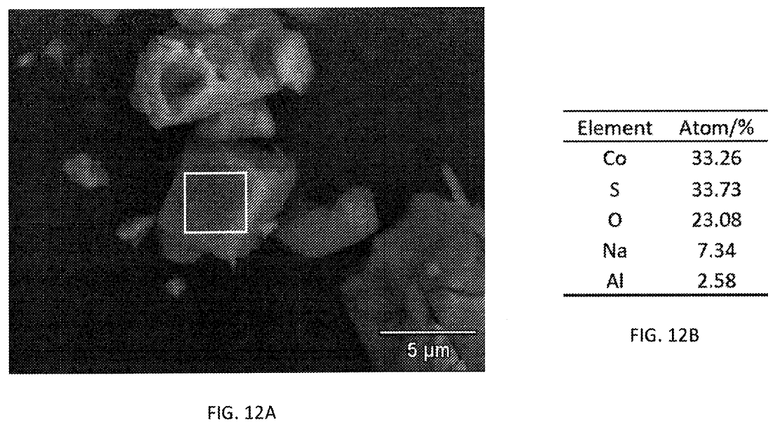

An SEM image and EDS mapping of the residue leached by 0.5 M glycine and 1.0 M Na₂S₂O₅ (sample S3) was obtained. In contrast to the leaching residue with low concentration, a different morphology of sample S3 was observed. Cubic-shaped particles around 5 micrometers and some smaller irregular particles were seen at the magnification shown in FIG. 10. FIG. 11A shows a higher magnification SEM of the particles, and FIGS. 11B-11F show element mapping of the same particles for the elements Co, O, S, Na and C, respectively. The EDS analysis showed that Co (FIG. 11B) and S (FIG. 11C) were evenly distributed in the residue. The element maps for O (FIG. 11D) and Na (FIG. 11E) were overlapped and especially enriched in the areas of irregular particles, indicating the residue consisted of different compositions. The cubic particle was further analyzed by EDS area mapping (inset area of FIG. 12A) and the element composition is summarized in FIG. 12B. The elements Co and S were in an atomic ratio of 1:1, suggesting that the cubic-shaped particle might be CoSO₄, given that oxygen was underestimated in EDS analysis.

It may be worth noting that the detection of lithium may have been unsuccessful because its characteristic radiation is very low. But according to leaching results, the precipitate also contained Li and its recovery dropped from 90 min to 180 min, as was shown in FIG. 3B. Without wishing to limit the invention to a particular theory or mechanism, lithium extraction in FIG. 3B decreased possibly because of the precipitation of lithium in the solution. Thus, the residue was possibly a coprecipitation of sulfate salts of Co, Li, and Na.

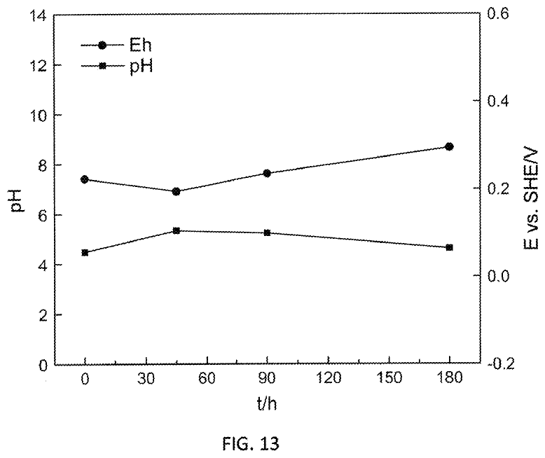

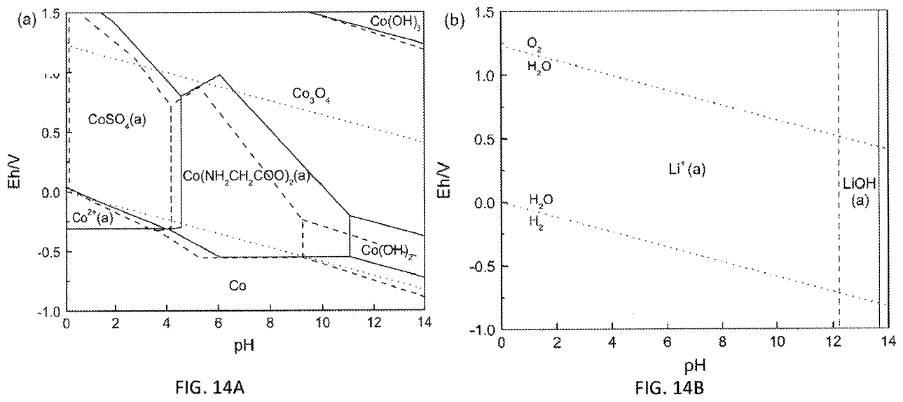

During the leaching process, solution pH and oxidation-reduction potential (ORP) were recorded, with results as shown in FIG. 13. Additionally, the pH-Eh diagrams of Co and Li in the glycine-SMB leaching system at 25° C. and 80° C. were computed using the EPH MODULE OF HSC CHEMISTRY 9 software, with results displayed in FIG. 14A (for Co) and FIG. 14B (for Li). Glycine and Na₂S₂O₅ concentrations were both set at 0.5 M, and the Co⁺ and Li⁺ concentrations were 0.2 M, corresponding to an S/L ratio of 20 g/L.

During LiCoO₂ leaching using glycine and SMB, the solution pH fluctuated between 4.5 and 5.3 and ORP was between 0.2 V and 0.3 V vs. SHE. In this pH range, the neutral form of glycine (⁺NH₃CH₂COO—) dominates. Zwitterionic glycine is reported to chelate with metal ions, but in very limited conditions (Keefer, 1948). According to a previous study, deprotonation of zwitterion glycine is a rapid step in the presence of high metal ion concentration (Pearlmutter and Stuehr, 1968). Therefore, it is supposed that Co(NH₂CH₂COO)₂ complexed by Co (II) and anionic glycine may be the dominant species in the leachate, although various cobalt-glycinate complexes may present.

In the Co—Li-glycine-SMB system, Co(NH₂CH₂COO)₂ was stable at pH 4-9 in a relative wide Eh range. Its stable region moved towards the lower pH direction at a higher temperature. Cobalt sulfate and free Co ion dominate the low pH region, where inorganic acid leaching is typically conducted. Cobalt is known to precipitate as Co(OH)₂ in an alkaline environment, which is why cobalt leaching using glycine is not conducted under alkaline solutions of copper and gold. Lithium ion tends not to form a complex with glycine, thus free Li⁺ is the dominant species in a wide pH and Eh range except strong alkaline conditions. Meanwhile, it has been acknowledged that partially hydrated lithium ion can complex with glycine (Remko and Rode, 2006). Based on the above discussion, the reaction of LiCoO₂ dissolution in the glycine-SMB system is proposed as Equation (7).

4 LiCoO₂+8NH₂CH₂COOH+Na₂S₂O₅→2Li₂SO₄+4Co(NH₂CH₂COO)₂+2NaOH+3H₂O (7)

Besides the main reaction, a series of reactions may happen after SMB is dissolved in aqueous solution, as illustrated in Equations (8)-(11) (Irwin, 2011). Sodium bisulfite (NaHSO₃) is produced once Na₂S₂O₅ dissolved in solution, and it may be further decomposed to produce S02 at high temperatures. Meanwhile, Na₂S₂O₅ may also be decomposed to Na₂SO₃ and SO₂ when the solution is heated. A portion of SO₂ dissolves and reacts with water to form H₂SO₃ and then dissociates to generate HSO₃⁻, which also shows reducing ability. These equations are the reason for high Na₂S₂O₅ demand in the leaching process.

H₂O+Na₂S₂O₅ [symbol] 2 NaHSO₃ (8)

2NaHSO₃→Na₂SO₃+H₂O+SO₂ (9)

Na₂S₂O₅→Na₂SO₃+SO₂ (10)

SO₂+H₂O→H₂SO₃→HSO₃⁺H⁺ (11)

Overall, the dissolution of LiCoO₂ in the glycine-SMB system can be described as follows. Na₂S₂O₅ attacks the LiCoO₂ crystal structure and reduces Co (III) to Co (II). Crystal defects appear after Co (II) was released to aqueous solution. Meanwhile, Li ion is also dissolved. Co (II) in solution is stabilized by glycine anion to form Co(NH₂CH₂COO)₂.

A distinct advantage of the leaching system lies in the mildly acidic leaching pH. The solution pH was near 5, which is higher than other organic acid leaching conditions. previous studies using organic acids as lixiviants, a relatively high acid concentration needs to be maintained to achieve high leaching efficiency because organic acid works as both proton provider and complexing agent (Fu et al., 2019; Li et al., 2015; Nayaka et al., 2016b). Glycine has a lower pKai (2.34) value compared with organic acids such as acetic acid (4.76), ascorbic acid (4.17), malic acid (3.40), tartaric acid (3.03) and citric acid (2.79). However, in this test, glycine just works as a chelating agent and does not release hydrogen ion to attack LiCoO₂ crystal (Golmohammadzadeh et al., 2018). On the other hand, fast leaching kinetics and high metal recovery can be achieved using a near stoichiometric amount of glycine in the glycine-SMB leaching system. Glycine was fully utilized by dissolved metal ions to form metal-glycinate complex.

The present disclosure includes embodiments of a method for recovering metal from a spent lithium-ion battery. In many instances, the cathode in spent LIBs includes LiCoO₂ adhered to an aluminum foil with an adhesive. It is desirable to separate the LiCoO₂ from the aluminum foil prior to leaching the LiCoO₂ for recovery of Co and Li. Hence, the method includes removing the removing the adhesive.

In some embodiments, removal of the adhesive from the LIB cathode includes physical breaking of the adhesive followed by air-separation or gravity separation.

By way of summary, Cobalt and lithium were extracted from LiCoO₂ by glycine with the aid of Na₂S₂O₅ as a reducing agent at 80° C. Preferred operating conditions were: 0.5 M glycine, 0.5 M Na₂S₂O₅, 20 g/L S/L ratio, at 80° C. for 180 min; the Co and Li recoveries obtained were 99.2% and 95.7% respectively. A shrinking core model was used to describe the dissolution process, and the apparent activation energies of Co and Li were 48.05 kJ/mol and 41.51 kJ/mol. Therefore, the controlling mechanism of the dissolution reaction was possibly a surface chemical reaction. XPS and SEM microanalytical characterizations of LiCoO₂ before and after leaching showed that it was not fully dissolved using low Na₂S₂O₅ concentrations, while higher Na₂S₂O₅ concentrations caused the precipitation formation, possibly due to high ionic strength of the solution.

In some embodiments according to the present disclosure, the glycine-SMB leaching system for LiCoO₂ dissolution was used under a mildly acidic environment at pH near 5. Glycine was utilized to form a metal-glycinate complex with high efficiency. Thus, the low reagent demands and near-neutral leaching condition in this leaching system as compared with other studies potentially offer an economic alternative to treat cathode material of spent lithium ion batteries.

### REFERENCES

A number of patents and publications are cited above in order to more fully describe and disclose the invention and the state of the art to which the invention pertains. Full citations for these references are provided below. Each of these references is incorporated herein by reference in its entirety into the present disclosure, to the same extent as if each individual reference was specifically and individually indicated to be incorporated by reference.
Ahmadi, F., Lee, Y. H., Lee, W. H., Oh, Y. K., Park, K. K., Kwak, W. S., Preservation of fruit and vegetable discards with sodium metabisulfite. J Environ Manage, 2018, 224, 113-121.
Angkawijaya, A. E., Fazary, A. E., Ismadji, S., Ju, Y.-H., Cu(II), Co(II), and Ni(II)-Antioxidative Phenolate-Glycine Peptide Systems: An Insight into Its Equilibrium Solution Study. Journal of Chemical & Engineering Data, 2012, 57(12), 3443-3451.
Azadi, M. R., Karrech, A., Attar, M., Elchalakani, M., Data analysis and estimation of thermodynamic properties of aqueous monovalent metal-glycinate complexes. Fluid Phase Equilibria, 2019, 480, 25-40.
Bahga, S. S., Bercovici, M., Santiago, J. G., Ionic strength effects on electrophoretic focusing and separations. Electrophoresis, 2010, 31(5), 910-919.
Borsook, H., Thimann, K. V., The cupric complexes of glycine and of alanine. Journal of Biological Chemistry, 1932, 98, 671-705.
Chen, S., He, T., Lu, Y., Su, Y., Tian, J., Li, N., Chen, G., Bao, L., Wu, F., Renovation of LiCoO 2 with outstanding cycling stability by thermal treatment with Li 2 CO 3 from spent Li-ion batteries. Journal of Energy Storage, 2016, 8, 262-273.
Dahe\acute{ } ron, L., Martinez, H., Dedryve\grave{ } re, R., Baraille, I., Me\acute{ } ne\acute{ } trier, M., Denage, C.,
Delmas, C., Gonbeau, D., Surface properties of LiCoO₂ investigated by XPS analyses and theoretical calculations. J. Phys. Chem. C, 2009, 113, 5843-5852.
Deng, D., Li-ion batteries: basics, progress, and challenges. Energy Science & Engineering, 2015, 3(5), 385-418.
Deutsch, J., Ascorbic acid oxidation by hydrogen peroxide. Anal Biochem, 1998, 255(1), 1-7.
Dos Santos, C. S., Alves, J. C., da Silva, S. P., Evangelista Sita, L., da Silva, P. R. C., de Almeida, L. C., Scarminio, J., A closed-loop process to recover Li and Co compounds and to resynthesize LiCoO₂ from spent mobile phone batteries. J Hazard Mater, 2019, 362, 458-466.
Eksteen, J. J., Oraby, E. A., Tanda, B. C., A conceptual process for copper extraction from chalcopyrite in alkaline glycinate solutions. Minerals Engineering, 2017, 108, 53-66.
Fleming, C., Wells, J., Thomas, K. G., 2000. Process for recovering gold from thiosulfate leach solutions and slurries with ion exchange resin. Barrick Gold Corporation, Toronto (CA), United States.
Flynn, N. E., Patyrak, M. E., Seely, J. B., Wu, G., Glycine oxidation and conversion into amino acids in Saccharomyces cerevisiae and Candida albicans. Amino Acids, 2010, 39(2), 605-608.
Fu, Y., He, Y., Qu, L., Feng, Y., Li, J., Liu, J., Zhang, G., Xie, W., Enhancement in leaching process of lithium and cobalt from spent lithium-ion batteries using benzenesulfonic acid system. Waste Manag, 2019, 88, 191-199.
Gao, W., Liu, C., Cao, H., Zheng, X., Lin, X., Wang, H., Zhang, Y., Sun, Z., Comprehensive evaluation on effective leaching of critical metals from spent lithium-ion batteries. Waste Manag, 2018, 75, 477-485.
Golmohammadzadeh, R., Faraji, F., Rashchi, F., Recovery of lithium and cobalt from spent lithium ion batteries (LIBs) using organic acids as leaching reagents: A review. Resources, Conservation and Recycling, 2018, 136, 418-435.
Guan, J., Li, Y., Guo, Y., Su, R., Gao, G., Song, H., Yuan, H., Liang, B., Guo, Z., Mechanochemical process enhanced cobalt and lithium recycling from wasted lithium-ion batteries. ACS Sustainable Chemistry & Engineering, 2016, 5(1), 1026-1032.
Han, S., Xia, Y., Wei, Z., Qiu, B., Pan, L., Gu, Q., Liu, Z., Guo, Z., A comparative study on the oxidation state of lattice oxygen among Lil.14Ni0.136Co0.136Mn0.54402, Li2MnO3, LiNi0.5Co0.2Mn0.3O2 and LiCoO₂ for the initial charge-discharge. Journal of Materials Chemistry A, 2015, 3(22), 11930-11939.
Irwin, S., 2011. A Comparison of the Use of Sodium Metabisulfite and Sodium Dithionite for Removing Rust Stains from Paper, In AIC's 39th Annual Meeting, Philadelphia, Pennsylvania, pp. 37-46.
Keefer, R. M., Interaction of ions and dipolar ions. IV. The solubility of cupric iodate in glycine and in alanine solutions. Journal of the American Chemical Society, 1948, 70(2), 476-479.
Levenspiel, O., Chemical reaction engineering. 3rd edn. 1999, New York: Wiley.
Li, J., Wang, G., Xu, Z., Environmentally-friendly oxygen-free roasting/wet magnetic separation technology for in situ recycling cobalt, lithium carbonate and graphite from spent LiCoO₂/graphite lithium batteries. J Hazard Mater, 2016, 302, 97-104.
Li, L., Qu, W., Zhang, X., Lu, J., Chen, R., Wu, F., Amine, K., Succinic acid-based leaching system: A sustainable process for recovery of valuable metals from spent Li-ion batteries. Journal of Power Sources, 2015, 282, 544-551.
Liu, Y., Xing, P., Liu, J., Environmental performance evaluation of different municipal solid waste management scenarios in China. Resources, Conservation and Recycling, 2017, 125, 98-106.
Lotfi, S., Mazloum-Ardakani, M., Ghasemi, J. B., Potentiometeric study of protonation and complex formation of some amino acids with Zn (II), Co(II) and Ni (II) in aqueous solution. Journal of the Iranian Chemical Research, 2009, 2, 247-255.
Musariri, B., Akdogan, G., Dorfling, C., Bradshaw, S., Evaluating organic acids as alternative leaching reagents for metal recovery from lithium ion batteries. Minerals Engineering, 2019, 137, 108-117.
Nayaka, G. P., Pai, K. V., Manjanna, J., Keny, S. J., Use of mild organic acid reagents to recover the Co and Li from spent Li-ion batteries. Waste Manag, 2016a, 51, 234-238.
Nayaka, G. P., Pai, K. V., Santhosh, G., Manjanna, J., Dissolution of cathode active material of spent Li-ion batteries using tartaric acid and ascorbic acid mixture to recover Co. Hydrometallurgy, 2016b, 161, 54-57.
Pearlmutter, A. F., Stuehr, J., Kinetics of copper (II)-glycine interactions in aqueous solution. Journal of the American Chemical Society, 1968, 90(4), 858-862.
Perea, C. G., Restrepo, O. J., Use of amino acids for gold dissolution. Hydrometallurgy, 2018, 177, 79-85.
Prasad, R., Prasad, S., Spectrophotometric determination of Iron(III)-Glycine formation constant in aqueous medium using competitive ligand binding. Journal of Chemical Education, 2009, 86(4), 494-497.
Remko, M., Rode, B. M., Effect of metal ions (Li+,Na+,K+,Mg2+,Ca2+,Ni2+,Cu2+, and Zn2+) and water coordination on the structure of glycine and zwitterionic glycine. The Journal of Physical Chemistry A, 2006, 110, 1960-1967.
Shin, D., Ahn, J., Lee, J., Kinetic study of copper leaching from chalcopyrite concentrate in alkaline glycine solution. Hydrometallurgy, 2019, 183, 71-78.
Smith, R. M., Martell, A. E., Critical stability constants. 1989, Plenum Press, New York.
Steward, D., Mayyas, A., Mann, M., Economics and challenges of Li-ion battery recycling from end-of-life vehicles. Procedia Manufacturing, 2019, 33, 272-279.
van Elp, J., Wieland, J. L., Eskes, H., Kuiper, P., Sawatzky, G. A., de Groot, F. M., Turner, T. S., Electronic structure of CoO, Li-doped CoO, and LiCoO₂. Phys Rev B Condens Matter, 1991, 44(12), 6090-6103.
Weidler, N., Paulus, S., Schuch, J., Klett, J., Hoch, S., Stenner, P., Maljusch, A., Brotz, J., Wittich, C., Kaiser, B., Jaegermann, W., CoOx thin film deposited by CVD as efficient water oxidation catalyst: change of oxidation state in XPS and its correlation to electrochemical activity. Phys Chem Chem Phys, 2016, 18(16), 10708-10718.
Zhang, T., He, Y., Wang, F., Li, H., Duan, C., Wu, C., Surface analysis of cobalt-enriched crushed products of spent lithium-ion batteries by X-ray photoelectron spectroscopy. Separation and Purification Technology, 2014, 138, 21-27.

We claim:

1. A method of leaching a metal-containing material (e.g., ore, concentrate, etc.), the method comprising:
a) forming a leach solution by dissolving at least one amino acid and a reducing agent in water;
b) forming a mixture of the leach solution of step (a) and a metal-containing material;
c) leaching at least one metal from the metal-containing material by heating the mixture of step (b) in a temperature range from about 20° C. to about 100° C. or about 10° C. to about 95° C.

2. The method of claim 1, wherein the metal-containing material comprises LiCoO₂.

3. The method of claim 1, wherein the at least one metal leached from the metal-containing material comprises lithium, cobalt, manganese or nickel (e.g, for battery recycling, using the present invention the metals leached may be manganese and/or nickel).

4. The method of claim 1, wherein the at least one amino acid is chosen from glycine, histidine and lysine.

5. The method of claim 4, wherein a concentration of the glycine in the leach solution is in a range from about 0.01M to about 2.0M, or from about 0.3 M to about 1.5 M, or even about 0.5 M.

6. The method of claim 1, wherein the reducing agent is sodium metabisulfite.

7. The method of claim 6, wherein a concentration of the sodium metabisulfite in the leach solution is in a range from about 0.1M to about 2.0 M, or from about 0.1 M to about 1.0 M, or even about 0.5 M.

8. The method of claim 1, further comprising adjusting the pH of the leach solution to a pH from about 1 to about 14, or from about 3 to about 7, or even from about 4.5 to 5.5.

9. The method of claim 1, wherein the metal-containing material is leached for a duration of about 10 minutes to about 180 minutes, or about 1 hour to about 96 hours.

10. A method of recovering metal from a spent lithium-ion battery cathode, the method comprising:
a) separating the cathode components comprising separating an aluminum foil in the cathode from a lithium containing material to recover one or more lithium compounds;
b) forming a leach solution by dissolving glycine and sodium metabisulfite in water;
c) forming a mixture of the leach solution of step (b) and said lithium containing material from step (a);
d) leaching at least lithium and/or cobalt from the lithium containing material by heating the mixture of step (c) in a temperature range from about 20° C. to about 100° C.

11. The method of claim 10, wherein the separating in step (a) comprises physical separating using a method comprising crushing, milling, and/or air/gravity separation and collecting resulting or separated said lithium containing material (e.g. LiCoO₂).

12. The method of claim 1, wherein said metal-containing material is an ore or concentrate.

13. The method of claim 1, said temperature range is from about 10° C. to about 95° C.

14. A method for leaching nickel and/or manganese from used batteries, the method comprising:
a) separating a nickel and/or manganese containing material from the used battery;
b) forming a leach solution by dissolving at least one amino acid and a reducing agent in water;
c) forming a mixture of the leach solution of step (b) and the nickel and/or manganese containing material;
d) leaching at least nickel and/or manganese from the nickel and/or manganese containing material by heating the mixture of step (c) in a temperature range from about 20° C. to about 100° C. or about 10° C. to about 95° C. wherein said at least one amino acid is chosen from glycine, histidine and lysine.

15. The method of claim 14, wherein said a reducing agent is sodium metabisulfite (SMB).

16. The method of claim 14, said temperature range is from about 10° C. to about 95° C.

17. The method of claim 14, wherein said lithium containing material comprises LiCoO₂.
